(19) United States
(12) Patent Application Publication
(10) Pub. No.: US 2003/0208760 A1
(43) Pub. Date: Nov. 6, 2003

(54) Electronic program guide providing device

(76) Inventors: Toyokazu Sugai, Tokyo (JP); Yuka Fujita, Tokyo (JP); Yoshiaki Kato, Tokyo (JP)

Correspondence Address: BIRCH STEWART KOLASCH & BIRCH, PO BOX 747, FALLS CHURCH, VA, 22040-0747, US

(21) Appl. No.: 09/802,961

(22) Filed: Mar. 12, 2001

Related U.S. Application Data
(63) Continuation of application No. PCT/JP99/07358, filed on Dec. 27, 1999.

(30) Foreign Application Priority Data
Aug. 4, 1999 (JP) 11-221082

(51) Int. Cl. H04N 5/445

(52) U.S. Cl. 725/50; 725/39

(57) ABSTRACT

An electronic program guide providing device can include editor units (31 and 32) each for updating electronic program information which has already been stored in an electronic program information storage unit (11). When each of the editor units updates the electronic program information stored in the electronic program information storage unit, it notifies a table generation unit (21) of update information on the updating at the same time. The table generation unit determines which table is to be regenerated based on the update information, and regenerates only one or more tables that need to be regenerated.

### CROSS-REFERENCE TO THE RELATED APPLICATION

This application is a continuation of International Application No. PCT/JP99/07358, whose international filing date is Dec. 27, 1999, the disclosures of which Application are incorporated by reference herein. The benefit of the filing and priority dates of the International Application is respectfully requested.

### BACKGROUND OF THE INVENTION

1. Field of the Invention

The present invention relates to an electronic program guide providing device for editing electronic program information on electronic programs provided by broadcasting such as digital television broadcasting, and for generating an electronic program guide table from the edited electronic program information.

2. Description of the Prior Art

Japanese patent application publication (TOKKAIHEI) No. 11-69319 discloses an electronic program information service device as a prior art electronic program guide providing device. In this prior art electronic program information service device, EPG (Electronic Program Guide) input terminal equipment, which is an editor unit, edits EPG information and inputs it to the device, and the input EPG information is stored in a database. A EPG table generation unit generates various tables which constitute an electronic program guide, such as NIT (Network Information Table), SDT (Service Description Table), and EIT (Event Information Table) at predetermined intervals based on the EPG information stored in the database, and then sends those tables as TS (Transport Stream) packets to outside the device. A problem with a prior art electronic program guide providing device constructed as above is that since it generates all various tables which constitute the electronic program guide, such as NIT, SDT, and EIT, and sends them to outside the electronic program guide providing device at predetermined intervals even when only a part of the EPG information is updated, the device is put on an enormous load.

### SUMMARY OF THE INVENTION

The present invention is proposed to solve the above-mentioned problem and it is therefore an object of the present invention to provide an electronic program guide providing device capable of reducing the load of generating various tables which constitute an electronic program guide table.

In accordance with an aspect of the present invention, there is provided an electronic program guide providing device including an editor unit for editing electronic program information, an electronic program information storage unit for storing the electronic program information edited by the editor unit, and a table generation unit for generating an electronic program guide table by using the electronic program information stored in the electronic program information storage unit, the device providing the generated electronic program guide table, wherein when updating the electronic program information stored in the electronic program information storage unit, the editor unit generates update information on the updating of the electronic program information, and the table generation unit updates the electronic program guide table based on the update information generated by the editor unit by using the electronic program information stored in the electronic program information storage unit.

Accordingly, the electronic program guide providing device makes it possible to update the electronic program guide table based on the update information and to omit unnecessary update processes, thus reducing the amount of processing carried out when generating the electronic program guide table.

In accordance with another aspect of the present invention, the electronic program guide providing device includes an update information storage unit for storing the update information generated by the editor unit, and, when updating the electronic program information stored in the electronic program information storage unit, the editor unit stores the update information on the updating of the electronic program information in the update information storage unit and the table generation unit generates the electronic program guide table based on the update information stored in the update information storage unit by using the electronic program information stored in the electronic program information storage unit.

Accordingly, the electronic program guide providing device makes it possible to update the electronic program guide table based on the update information stored in the update information storage unit and to omit unnecessary update processes, thus reducing the amount of processing carried out when generating the electronic program guide table.

In accordance with a further aspect of the present invention, the electronic program guide table consists of a plurality of electronic program information tables each of which corresponds to the type of electronic program information included therein, and the table generation unit determines which electronic program information table has to be updated based on the update information on the updating of the electronic program information, and updates only one or more electronic program information tables that need to be updated.

Accordingly, the electronic program guide providing device makes it possible to update and provide only one or more electronic program information tables that have to be regenerated based on the update information and to omit unnecessary update processes, thus reducing the amount of processing carried out when generating the electronic program guide table.

In accordance with another aspect of the present invention, the table generation unit updates only one or more electronic program information tables that need to be updated at predetermined intervals.

Accordingly, the electronic program guide providing device makes it possible to finish the desired updating with only one table regeneration no matter how many the table generation unit is notified of the update information by the editor unit is notified during each interval, thus omitting unnecessary updating processes.

In accordance with a further aspect of the present invention, the table generation unit sets the length of predetermined intervals at which only one or more electronic program information tables that need to be updated are updated according to a sending frequency of an electronic program information table with the largest sending frequency.

Accordingly, the electronic program guide providing device makes it possible to keep the contents of each electronic program information table up to date anytime even when table updating is carried out at predetermined intervals.

In accordance with another aspect of the present invention, the table generation unit sets the length of predetermined intervals at which each of one or more electronic program information tables that need to be updated is updated according to a sending frequency of each of the one or more electronic program information tables.

Accordingly, the electronic program guide providing device makes it possible to efficiently update and transmit each electronic program information table.

In accordance with a further aspect of the present invention, the device includes a plurality of editor unit, and each of the plurality of editor unit inspects update information generated by any other editor unit stored in the update information storage unit.

Accordingly, the electronic program guide providing device makes it possible to update the electronic program information according to the contents of updating done by any other editor unit and to prevent any updating done by one of the plurality of editor unit from colliding with and contradicting the contents of updating done by any other editor unit.

In accordance with another aspect of the present invention, the update information storage unit stores histories of the update information generated by the editor unit, and the editor unit restores the electronic program information stored in the electronic program information storage unit to the state it was prior to any updating done by the editor unit with reference to the histories of the update information stored in the update information storage unit if necessary.

Accordingly, the electronic program guide providing device makes it possible to restore the electronic program information stored in the electronic program information storage unit the state it was prior to any updating previously done by any editor unit with reference to the histories of the update information.

In accordance with a further aspect of the present invention, the table generation unit determines whether the updating of the electronic program information done by the editor unit causes something wrong in the generation of the electronic program guide table, when determining so, notifies the editor unit that there causes something wrong in the generation of the electronic program guide table, and invalidates the updating of the electronic program information.

Accordingly, the electronic program guide providing device makes it possible for the editor to re-edit the electronic program information to modify the electronic program information so that it has a format that meets all limitations imposed by a given standard, thus preventing editing of the electronic program information which does not meet any limitation imposed by the standard.

In accordance with another aspect of the present invention, the table generation unit determines whether the updating of the electronic program information done by the editor unit causes something wrong in the generation of the electronic program guide table, when determining so, notifies the editor unit that there causes something wrong in the generation of the electronic program guide table, and urges the editor unit to re-edit the electronic program information.

Accordingly, the electronic program guide providing device makes it possible for the editor to re-edit the electronic program information to modify the electronic program information so that it has a format that meets all limitations imposed by a given standard, thus preventing editing of the electronic program information which does not meet any limitation imposed by the standard.

In accordance with a further aspect of the present invention, the table generation unit determines whether the updating of the electronic program information done by the editor unit causes something wrong in the generation of the electronic program guide table, when determining so, notifies the editor unit that there causes something wrong in the generation of the electronic program guide table, and restores the electronic program information stored in the electronic program information storage unit to the state it was prior to the updating of the electronic program information with reference to the histories of the update information stored in the update information storage unit.

Accordingly, the electronic program guide providing device makes it possible to restore the electronic program information to the state it was prior to any updating previously done by any editor unit and also makes it possible for the editor to re-edit the electronic program information to modify the electronic program information so that it has a format that meets all limitations imposed by a given standard, thus preventing editing of the electronic program information which does not meet any limitation imposed by the standard.

In accordance with another aspect of the present invention, the device includes a plurality of table generation unit for generating the electronic program guide table while sharing a load of generating the electronic program guide table.

Accordingly, the electronic program guide providing device makes it possible to distribute the load of generating the electronic program guide table among the plurality of table generation units.

In accordance with a further aspect of the present invention, the table generation unit provides the generated electronic program guide table at predetermined intervals, and, when updating the electronic program guide table, provides the electronic program guide table updated at the same time that it updates the electronic program guide table.

Accordingly, the electronic program guide providing device makes it possible to, once the table generation unit is notified of updating of the electronic program guide table, transmit the updated table at an earlier time even though the table generation unit is so constructed as to send the electronic program guide table at predetermined intervals.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of an electronic program guide providing device according to a first embodiment of the present invention;

FIG. 2 is a diagram showing an example of an electronic program guide table;

FIG. 3 is a diagram showing an example of EIT updated by the electronic program guide providing device according to the first embodiment of the present invention;

FIG. 4 is a timing chart showing timing of an example of table updating carried out by a table generation unit of an electronic program guide providing device according to a second embodiment of the present invention;

FIG. 5 is a timing chart showing timing of an example of table updating carried out by a table generation unit of an electronic program guide providing device according to a fourth embodiment of the present invention;

FIG. 6 is a block diagram showing the structure of an electronic program guide providing device according to a fifth embodiment of the present invention;

FIG. 7 is a block diagram showing the structure of an electronic program guide providing device according to a seventh embodiment of the present invention;

FIG. 8 is a block diagram showing the structure of an electronic program guide providing device according to a ninth embodiment of the present invention; and

FIGS. 9(a) to 9(c) are timing charts showing an example of generation and transmission of tables carried out by an electronic program guide providing device according to a tenth embodiment of the present invention.

### DETAILED DESCRIPTION OF THE PREFERRED EMBODIMENTS

Embodiment 1.

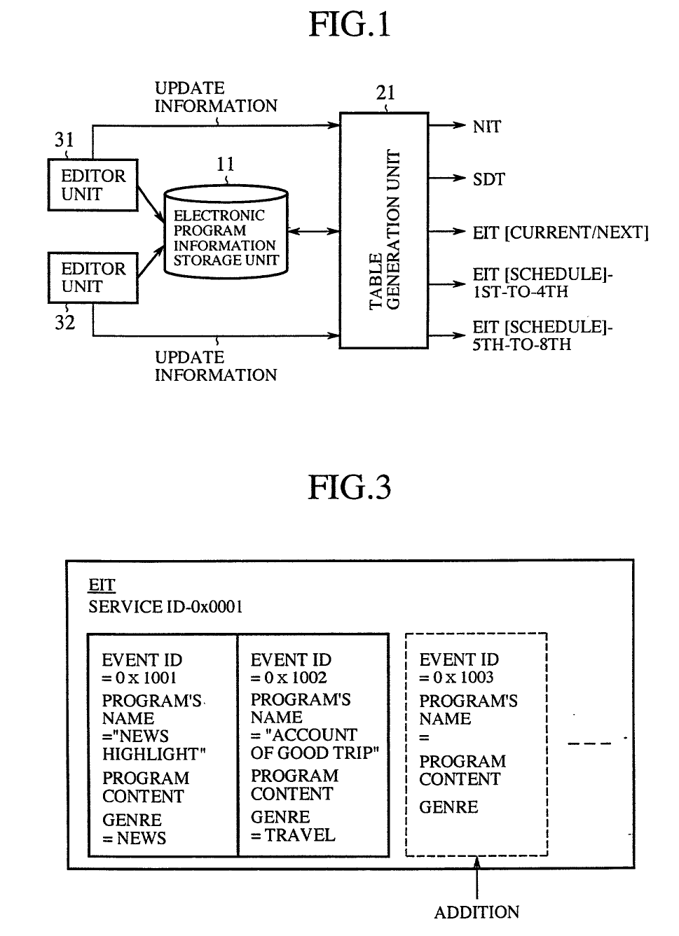

FIG. 1 is a block diagram showing the structure of an electronic program guide providing device according to a first embodiment of the present invention. In the figure, reference numeral 11 denotes an electronic program information storage unit for storing program information edited or updated by either of editor units 31 and 32 which will be described later, and numeral 21 denotes a table generation unit for generating various tables which constitute an electronic program guide (EPG) table in an available format defined by the ATSC standard (Program and System Information Protocol for Terrestrial and Cable) in the United States or the ARIB standard (standard concerning the array of electronic program information for use with digital broadcasting) in Japan with reference to the electronic program information stored in the electronic program information storage unit 11. Each of the editor units 31 and 32 enables any editor to newly edit electronic program information, store this edited electronic program information in the electronic program information storage unit 11, and also to update the electronic program information stored in the electronic program information storage unit 11. Each of the editor units also provides information on the electronic program information editing or the electronic program information updating generated as a result of the electronic program information editing or the electronic program information updating to the table generation unit 21. For simplicity, assume that the electronic program guide providing device according to either of the following embodiments of the present invention includes the two editor units 31 and 32 that enable two editors to simultaneously edit or update electronic program information. Nevertheless, it is needless to say that the electronic program guide providing device according to either of the embodiments of the present invention only has to have at least one editor unit, and the electronic program guide providing device according to the present invention can alternatively have three editor units or more. It is also apparent that the electronic program information storage unit 11, the table generation unit 21, and the editor units 31 and 32, which constitute the electronic program guide providing device according to the first embodiment, can be separately disposed such that they can communicate with each other via a cable or wireless communication line.

In the following, assume that the table generation unit 21 outputs various tables which constitute the electronic program guide table according to the ARIB standard in Japan, for example. The electronic program guide table defined by the ARIB standard consists of a plurality of units of information, each of which is called “table” and which differ from each other in the type of information. For example, the electronic program guide table includes various tables: one which is called NIT for storing information associated with a network, one which is called SDT for storing information associated with channels (or services) organized by a broadcaster, and one which is called EIT for storing information associated with each electronic program (or event) in one channel.

Furthermore, as for EIT, a table which shows current and next events such as “an event being broadcasted now and an event to be broadcasted next”, and some tables each of which shows “events to be broadcasted within X days of today (or day after several days from today)” are separately generated. As shown in FIG. 1, the former one is referred to as EIT[current/next] and the latter one is referred to as EIT[schedule]. According to the first embodiment, some EIT[schedule] tables are generated separately such that each of them shows events for every four days. For example, they include EIT[schedule]-1st-to-4th showing events to be broadcasted within four days of today, EIT[schedule]-5th-to-8th showing events to be broadcasted within four days of the fifth day from today, and so on.

Next, an example of the electronic program guide table will be shown, and which information is stored in which one of various tables will be explained.

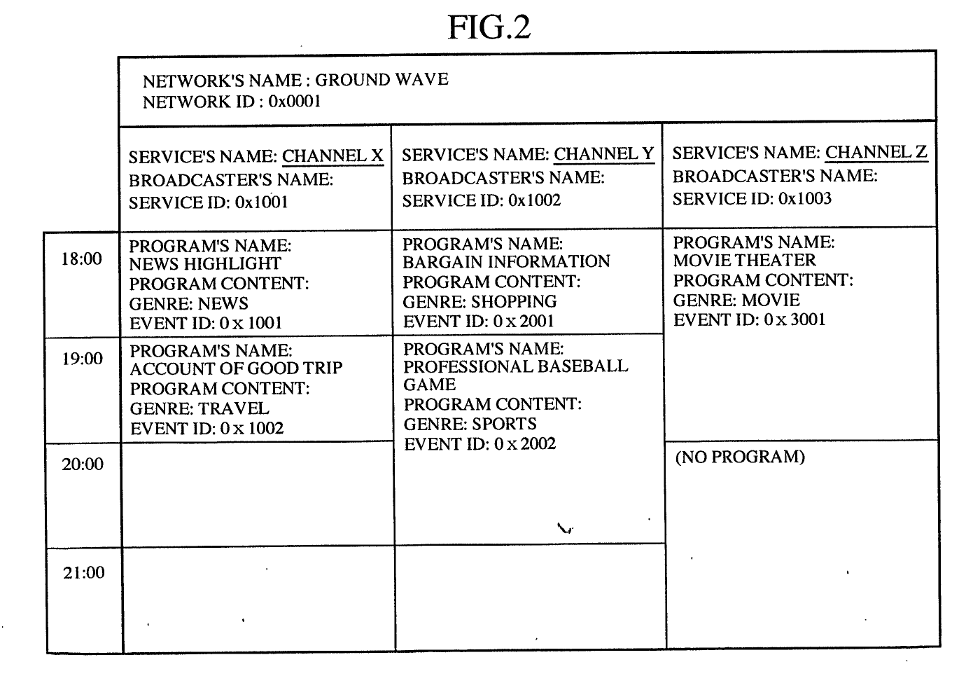

FIG. 2 shows an example of the electronic program guide table when three channels (services) X to Z are broadcasted in a ground wave network. The electronic program guide table consists of pieces of information on various tables shown in FIG. 2, and information about the network such as “network's name” and “network ID” is provided with being stored in NIT. Information about services such as “service's name”, “broadcaster”, and “service ID” is provided with being stored in SDT, and information about electronic programs such as “program's name”, “program content”, “genre”, and “event ID” is provided with being stored in EIT.

In operation, electronic program information edited and input or updated with either of the editor units 31 and 32 is stored in the electronic program information storage unit 11. The table generation unit 21 reads the electronic program information stored in the electronic program information storage unit 11, and then generates various tables such as NIT, SDT, and EIT.

When an editor uses either of the editor units 31 and 32 to add new electronic program information or change or delete the electronic program information which has already been input, for example, so that he or she updates the electronic program information stored in the electronic program information storage unit 11, the editor unit 31 or 32 carries out the desired updating of the electronic program information stored in the electronic program information storage unit 11 according to the input of the editor, and notifies the table generation unit 21 of update information on the updating, such as information showing which information was updated like information showing whether information on which event (electronic program) ID was updated, and information showing how the electronic program information was updated, such as information showing a new addition of one or more events (electronic programs), modification of the contents of one or more existing events (electronic programs), or deletion of one or more existing events (electronic programs). Then, the table generation unit 21 can recognize which piece of electronic program information has been updated and how it has been updated based on the notified update information. So, the table generation unit 21 can determine which table has to be regenerated. For example, when one or more electronic programs are added to the electronic program information, the table generation unit 21 determines that it needs to regenerate EIT, but need not regenerate NIT and SDT.

FIG. 3 shows an example of an update of EIT. Event information included in EIT is organized in service unit. In the example of FIG. 3, a group of electronic programs included in service ID=0x0001 is organized. EIT includes EIT[current/next] for storing a current event being broadcasted now and an event to be broadcasted next, and some EIT[schedule] tables each for storing some events to be broadcasted within four days as a unit, such as EIT[schedule]-1st-to-4th for storing events to be broadcasted within four days of today, EIT[schedule]-5th-to-8th for storing events to be broadcasted within four days of the fifth day from today, and so on.

Here, assume a case to add an electronic program of event ID=0x1003 and broadcasting time 20:00-21:00 to the service name “channel X” in FIG. 2, for example, as shown in FIG. 3. Assuming that the electronic program schedule shown in FIG. 2 is the one of today, and the current time is 18:00, since although the added event is an event of today, it is neither an event being broadcasted now nor an event to be broadcasted next, the table generation unit 21 regenerates EIT[schedule]-1st-to-4th whose contents are updated, but does not update EIT[current/next]. The table generation unit 21 does not update any other EIT with another service ID.

Since the table generation unit 21 thus recognizes that it only has to regenerate one of some EITs [schedule] with service ID=0x0001, that is, the one showing events to be broadcasted within four days of today, it regenerates and transmits only the EIT[schedule] again.

As mentioned above, in accordance with the first embodiment of the present invention, since the table generation unit 21 determines which one or more tables have to be regenerated based on update information notified from the editor units 31 and 32, and then regenerates only the one or more tables which have to be regenerated, the first embodiment offers an advantage of being able to omit an unnecessary updating process, and therefore to reduce the amount of processing when regenerating the tables.

Embodiment 2.

The electronic program guide providing device according to the above-mentioned first embodiment can reduce the amount of table generation processing by regenerating only one or more tables which have to be updated by means of the table generation unit 21. In contrast, an electronic program guide providing device according to a second embodiment of the present invention determines whether to have to regenerate one or more tables based on update information from either or both of editor units 31 and 32 which a table generation unit 21 accepts at predetermined intervals. In the electronic program guide providing device according to the second embodiment, only since the table generation unit 21 has a function slightly different from that of the table generation unit 21 according to the above-mentioned first embodiment, only a specific processing performed by the table generation unit 21 will be explained hereafter with reference to the configuration of the electronic program guide providing device according to the above-mentioned first embodiment shown in FIG. 1.

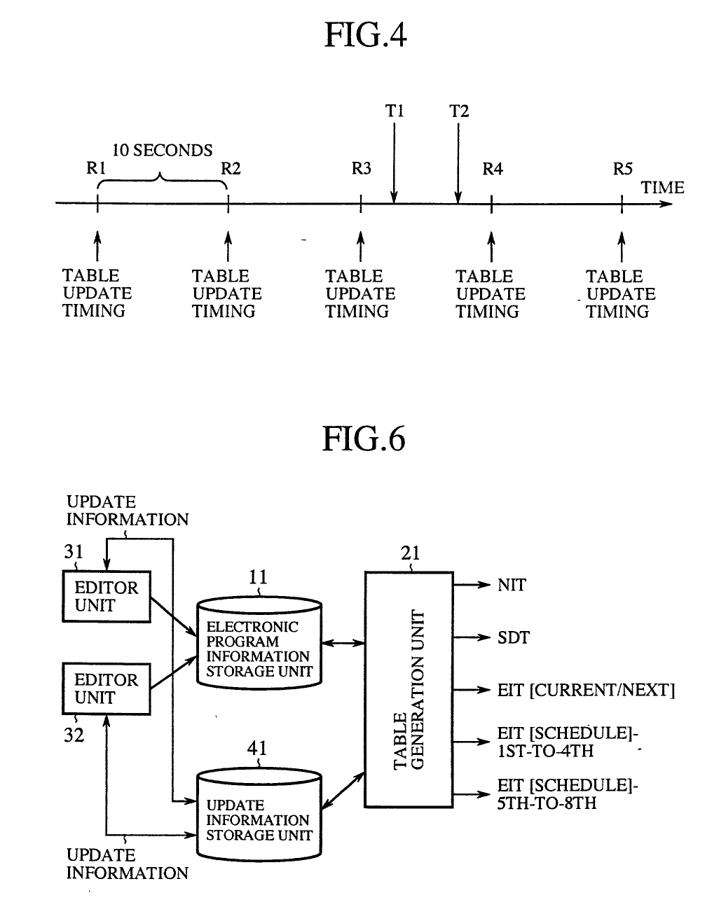

FIG. 4 is a timing chart showing an example of the time flow of processing done by the table generation unit 21 of the electronic program guide providing device according to the second embodiment of the present invention.

The table generation unit 21 determines whether there exist one or more tables which have to be updated at predetermined intervals, for instance, every 10 seconds. If there exist one or more table which have to be updated, the table generation unit 21 regenerates those tables. For example, the table generation unit 21 can update one or more tables with timing corresponding to times R1 to R5 as shown in FIG. 4.

As shown in FIG. 4, no updating process has not been performed at times R1 to R3 since the table generation unit 21 has not been notified of any update information on updating of the electronic program information from the editor units 31 and 32 at times R1 to R3, even if the table generation unit 21 will be notified of update information on updating of the electronic program information by the editor unit 31 at time T1, and will be further notified of update information on other updating of the electronic program information by the editor unit 32 at time T2. And, when the table generation unit 21 is successively notified of two pieces of update information on updating of the electronic program information at times T1 and T2 by the editor units 31 and 32, the table generation unit 21 carries out regeneration of corresponding tables according to those pieces of update information at once at time R4 since the table generation unit 21 performs table updating only at predetermined intervals. For example, if the contents of the updating with the editor unit 31 and the contents of the other updating with the editor unit 32 are both associated with an event (electronic program) with table ID=0x0001, the target table which the table generation unit 21 has to regenerate at time R4 is “EIT with table ID=0x0001” for both the updates of the electronic program information.

Therefore, although according to the above-mentioned first embodiment the table generation unit regenerates tables upon the arrival of update information from either of the editor units 31 and 32, and therefore table regeneration is needed in every case (table regeneration is carried out two times in the above-mentioned example), the table generation unit 21 according to the second embodiment can finish the desired updates with only one table regeneration, thus omitting an unnecessary updating process. As a result, the amount of table generation processing carried out by the table generation unit 21 can be reduced.

Therefore, in accordance with the second embodiment of the present invention, since the table generation unit 21 generates tables at predetermined intervals, it can finish one or more desired updates by only one table regeneration no matter how many pieces of update information from either or both of the editor units are notified within each interval time, thus omitting unnecessary updating processes. As a result, the second embodiment offers an advantage of being able to reduce the amount of processing carried out by the table generation unit 21.

Embodiment 3.

The electronic program guide providing device according to the above-mentioned second embodiment determines whether to have to regenerate tables based on update information from either or both of the editor units 31 and 32 which the table generation unit 21 accepts at predetermined intervals. In contrast, an electronic program guide providing device according to a third embodiment of the present invention sets the length of predetermined intervals at which a table generation unit 21 accepts update information to update tables, i.e., table update timing (i.e., frequency) according to the transmission interval of one table with the shortest transmission interval, i.e., one table with the largest sending frequency. As a result, the sending frequencies of all electronic program information tables that conform to the standard can be achieved.

As for tables defined by the ARIB standard, since a lower limit of the sending frequency is set for each table type according to the standard, it is necessary to repeatedly transmit each table to keep its sending frequency more than the lower limit, and when updating the electronic program information it is also necessary to reflect the contents of the updating in each table.

For example, since EIT[current/next] is the table with the shortest transmission interval and has to be transmitted one or more times every two seconds, it is necessary to set the table update frequency with which each table can be updated by the table generation unit 21 to one or more times every two seconds if EIT[current/next] is repeatedly transmitted once every two seconds. If not, there causes a situation of transmitting EIT[current/next] in which no updating is reflected even though the table generation unit is notified of updating of the electronic program information. The table generation unit of the third embodiment can update tables at predetermined intervals, like the above-mentioned second embodiment, and features setting of the length of predetermined intervals according to the transmission interval of one table with the shortest transmission interval, i.e., EIT[current/next], among all tables. Therefore, even when table updating is carried out at predetermined intervals, the contents of each table can be kept up to date anytime, like the above-mentioned first embodiment.

As previously mentioned, in accordance with the third embodiment of the present invention, the table generation unit can update tables at predetermined intervals whose length is preset according to the transmission interval of one table with the shortest transmission interval, i.e., EIT[current/next], among all tables. Accordingly, the third embodiment offers an advantage of being able to keep the contents of each table up to date anytime even when table updating is carried out at predetermined intervals, like the above-mentioned first embodiment. As a result, the electronic program guide providing device according to the third embodiment can efficiently update and transmit each table compared with the above-mentioned first and second embodiments.

Embodiment 4.

The electronic program guide providing device according to the above-mentioned third embodiment makes the length of predetermined intervals at which tables can be updated based on update information, i.e., the table update frequency with which the tables can be updated match the transmission interval of one table with the shortest transmission interval among all tables. In contrast, an electronic program guide providing device according to a fourth embodiment of the present invention sets the length of predetermined intervals at which each table can be updated, i.e., the table update frequency with which each table can be updated according to the transmission frequency of each table, i.e., regular transmission intervals at which each table is transmitted.

As mentioned above, the lower limit of the sending frequency of a table defined by the ARIB standard is different depending on the type of the table. For example, while the sending frequency of EIT is set to one time every two seconds, the sending frequency of NIT is set to one time every ten seconds. In this way the sending frequencies of tables are different from each other. A table generation unit 21 of the electronic program guide providing device according to the fourth embodiment sets the table update frequency with which each table can be updated according to the sending frequency of each table, i.e., regular transmission intervals at which each table is transmitted. For each table such as NIT, SDT, and EIT, the length of predetermined intervals at which each table can be updated is set according to the sending frequency of each table.

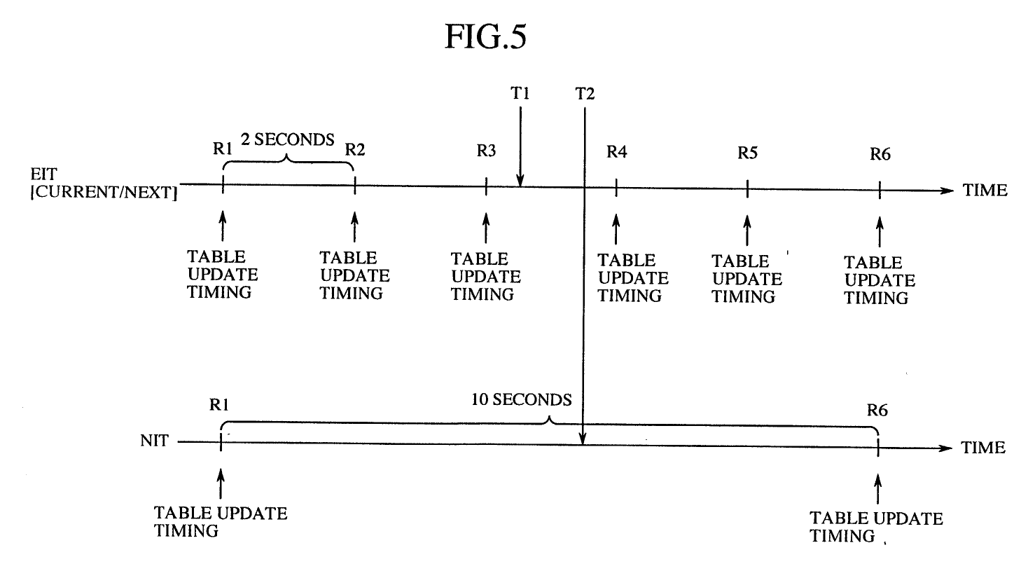

FIG. 5 shows an example of the table update timing (i.e., frequency) of each table according to the fourth embodiment. In the example as shown in FIG. 5, the table generation unit 21 sets the table update timing for EIT[current/next] to R1, R2, . . . , R6, . . . , i.e., sets the table updating frequency to one time every two seconds. On the other hand, the table generation unit 21 sets the table update timing for NIT to R1, R6, . . . , i.e., sets the table updating frequency to one time every ten seconds. Assuming that an editor unit 31 notifies the table generation unit 21 of update information indicating updating of each table at time T1, and an editor unit 32 notifies the table generation unit 21 of update information indicating updating of each table at time T2.

When the table generation unit 21 determines that updating of EIT[current/next] is needed based on the update information from the editor unit 31, it updates EIT[current/next] at R4 which is the next table update timing for EIT[current/next]. On the other hand, the table generation unit 21 updates NIT at R6 which is the next table update timing for NIT when determining that updating of NIT is needed based on the update information from the editor unit 32.

Therefore, in accordance with the fourth embodiment of the present invention, the table generation unit 21 sets the table update timing (i.e., frequency) for each table according to the transmission frequency defined for each table, i.e., regular transmission intervals at which each table is transmitted. Accordingly, the electronic program guide providing device according to the fourth embodiment can efficiently update and transmit each table.

Embodiment 5.

In the electronic program guide providing device according to either of the first through fourth embodiments mentioned above, each of the editor units 31 and 32 directly notifies the table generation unit 21 of update information on updating of the electronic program information. In contrast, an electronic program guide providing device according to a fifth embodiment of the present invention prevents both of editor units 31 and 32 from directly notifying a table generation unit 21 of update information on updating of the electronic program information.

FIG. 6 is a block diagram showing the structure of the electronic program guide providing device according to the fifth embodiment of the present invention. In the figure, reference numeral 41 denotes an update information storage unit for storing update information output from either of the editor units 31 and 32. Each of the editor units 31 and 32 can inspect information on updating of the electronic program information performed by the other editor unit stored in the update information storage unit 41 by accessing the update information storage unit 41. Since the other structure of the electronic program guide providing device is the same as that of the electronic program guide providing device according to the above-mentioned first embodiment shown in FIG. 1, the same components are designated by the same reference numerals and the description of those components will be omitted hereafter.

In operation, when an editor uses either of the editor units 31 and 32 to add new electronic program information or change or delete the electronic program information which has already been input, for example, so as to update the electronic program information stored in an electronic program information storage unit 11, the editor unit 31 or 32 writes update information on the updating in the update information storage unit 41.

The table generation unit 21 accesses the update information storage unit 41 either continuously or at regular intervals, and refers to the update information written in the update information storage unit 41. The table generation unit 21 determines which one or more tables have to be regenerated, like the above-mentioned first through fourth embodiments, and then reads needed pieces of electronic program information stored in the electronic program information storage unit 11 and regenerates the one or more tables which have to be regenerated.

In this case, each of the editor units 31 and 32 can inspect the update information generated by the other editor unit by accessing the update information storage unit 41 and referring to the update information written in the update information storage unit 4 by the other editor unit.

Therefore, in accordance with the fifth embodiment of the present invention, since each of the editor units 31 and 32 can inspect update information generated by the other editor unit by way of the update information storage unit 4, the electronic program guide providing device of the fifth embodiment enables sharing of any update information between the editor units and can update the electronic program information according to the contents of updating done by any of the editor units. The electronic program guide providing device of the fifth embodiment can also prevent any updating done by one of the editor units from colliding with and contradicting the contents of updating done by the other editor unit.

Instead of disposing the update information storage unit 11 besides the table generation unit 21 as mentioned above, either the update information storage unit 11 or a storage unit, such as a memory or a disk drive, which has the same function as the update information storage unit 11 can be disposed within the table generation unit 21. Even an electronic program guide providing device of another embodiment including an update information storage unit 11, which will be explained below, can have the same structure.

Embodiment 6.

The electronic program guide providing device according to the above-mentioned fifth embodiment stores update information output from either of the editor units 31 and 32 in the update information storage unit 41 and makes it possible for not only the table generation unit 21 but both of the editor units 31 and 32 to access the update information stored in the update information storage unit 41 by any of the editor units, thus enabling sharing of the update information between the editor units. In contrast, an electronic program guide providing device according to a sixth embodiment of the present invention further enables restoration of the electronic program information by recording revision histories of update information in an update information storage unit 41.

In the electronic program guide providing device according to the sixth embodiment, the update information storage unit 41 shown in FIG. 6 records update information generated by either of editor units 31 and 32 one by one in order of occurrence and stores it as “update revision history”. Furthermore, when any of the editor units 31 and 32 performs updating, the electronic program guide providing device allows the editor unit to read information required for restoration of the electronic program information to the state it was prior to the updating, such as deleted information when the updating is a deletion process of deleting one or more pieces of electronic program information, or the contents of the previous electronic program information when the updating is a modification process of modifying the electronic program information, from an electronic program information storage unit 11 and transmit it to the update information storage unit 41 so that the update information storage unit 41 also stores it as “update revision history”.

Each of the editor unit 31 and 32 can refer to the update revision histories stored in the update information storage unit 41 if necessary, and can perform restoration of the electronic program information stored in the electronic program information storage unit 11 to the state it was prior to any updating previously done by any of the editor units 31 and 32.

Therefore, in accordance with the sixth embodiment of the present invention, the electronic program information stored in the electronic program information storage unit 11 can be restored to the state it was prior to any updating previously done by any of the editor units 31 and 32 with reference to “update revision histories” stored in the update information storage unit 41.

Embodiment 7.

In the above-mentioned first embodiment etc., the table generation unit 21 cannot generate or regenerate tables when the amount of information of the tables defined by a given standard, such as the ARIB standard, exceeds a limitation such as an upper limit of the amount of information. In contrast, an electronic program guide providing device according to a seventh embodiment of the present invention includes a table generation unit 21 that, in such a case, notifies a corresponding editor unit that the amount of information of tables defined by a given standard, such as the ARIB standard, exceeds a limitation, and assumes the updating of the electronic program information to be invalid or urges the editor to edit the electronic program information again to modify the electronic program information so that it has a format which meets the limitation imposed by the standard.

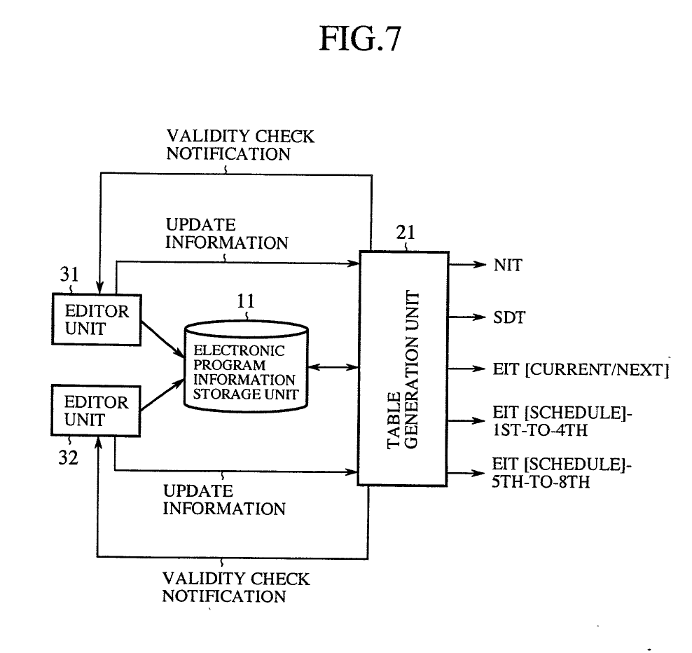

FIG. 7 is a block diagram showing the structure of the electronic program guide providing device according to the seventh embodiment of the present invention. When generating tables, the table generation unit 21 of the electronic program guide providing device according to the seventh embodiment shown in FIG. 7 checks whether the updating of the electronic program information does not meet limitations imposed by the ARIB standard, such as a limitation on the number of characters required for describing the contents of one electronic program and a limitation on the number of electronic programs which can be stored in one type of EIT, based on update information notified by either of editor units 31 and 32 and the electronic program information stored in an electronic program information storage device 11.

Then, when determining that the table generation caused by the updating does not meet a limitation, the table generation unit 21 notifies the editor unit which is the notification origin of the update information of the fact, and transmits validity check notification to the editor unit so as to cancel (or disable) the updating of the electronic program information or to urge the editor to re-edit the electronic program information. In response to the validity check notification, the editor unit which is the notification origin of the update information automatically cancels the updating of the electronic program information or notifies the editor that the updating is invalid. In the latter case, the editor can cancel the updating by himself or herself and re-edit the electronic program information. As an alternative, the editor unit can be so constructed as to, in response to the validity check notification, urge the editor to re-edit the electronic program information to modify the electronic program information so that it meets all limitations imposed by the standard.

Therefore, in accordance with the seventh embodiment of the present invention, even if either of the editor units 31 and 32 edits the electronic program information such that it does not meet a given standard such as the ARIB standard, the table generation unit 21 notifies either of the editor units 31 and 32 that the updating does not meet the standard, and cancels the updating of the electronic program information or urges the editor to re-edit the electronic program information to modify the electronic program information so that it has a format that meets all limitations imposed by the standard, thus preventing editing of the electronic program information which does not meet any limitation imposed by the standard.

Embodiment 8.

An electronic program guide providing device according to an eighth embodiment of the present invention includes a table generation unit 21 having a function of checking whether updating of electronic program information does not meet limitations imposed by a given standard, such as the ARIB standard, based on update information stored in an update information storage unit 41 and the electronic program information stored in an electronic program information storage device 11, and, when the table generation caused by the updating does not meet a limitation imposed by the standard, canceling the update information and referring to “update revision histories” stored in the update information storage unit 41 so as to perform restoration of the electronic program information stored in the electronic program information storage unit 11 to the state it was prior to the updating, in addition to the function according to the above-mentioned sixth embodiment.

Like the table generation unit 21 of the above-mentioned sixth embodiment, when determining that the edited electronic program information does not meet a limitation imposed by the standard, the table generation unit 21 notifies a corresponding editor unit which is the notification origin of the update information of the fact by transmitting validity check notification to the editor unit so as to urge the editor to re-edit the electronic program information, for example.

Therefore, in accordance with the eighth embodiment of the present invention, even if either of the editor units 31 and 32 edits the electronic program information such that it does not meet a given standard such as the ARIB standard, the table generation unit 21 performs restoration of the original electronic program information to the state it was prior to the updating based on the update information stored in the update information storage unit 41 and the electronic program information stored in the electronic program information storage unit 11. Like the seventh embodiment of the present invention, even if either of the editor units 31 and 32 edits the electronic program information such that it does not meet a given standard such as the ARIB standard, the table generation unit 21 notifies either of the editor units 31 and 32 that the updating does not meet the standard, and urges the editor to re-edit the electronic program information to modify the electronic program information so that it has a format that meets all limitations imposed by the standard, thus preventing editing of the electronic program information which does not meet any limitation imposed by the standard.

Embodiment 9.

The electronic program guide providing device according to the above-mentioned fifth embodiment includes a single table generation unit 21 for generating various tables with reference to the update information storage unit 41. An electronic program guide providing device according to a ninth embodiment of the present invention is provided with a plurality of table generation units, thus being able to make distribution of the load of generating one or more tables which constitute electronic program guide table among them.

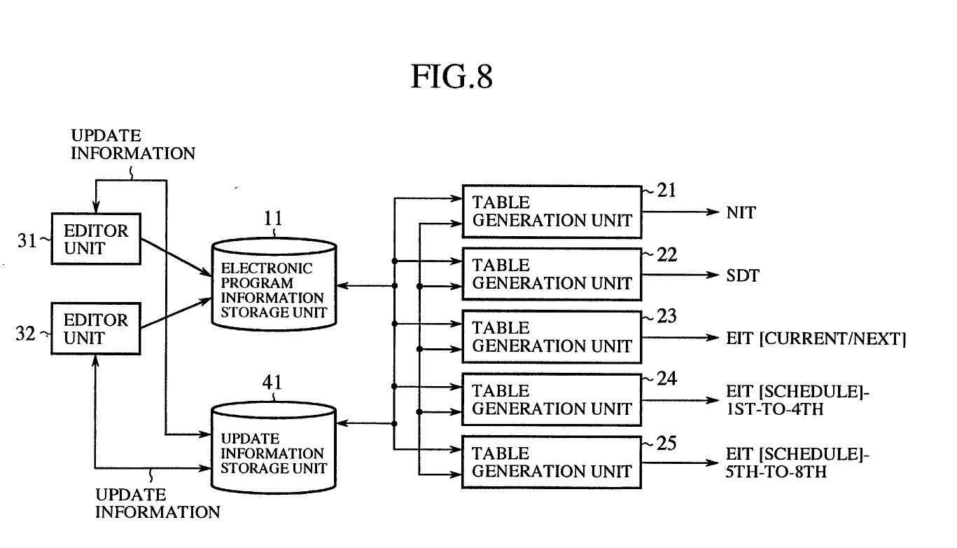

FIG. 8 is a block diagram showing the structure of the electronic program guide providing device according to the ninth embodiment of the present invention. Each of the plurality of table generation units 21 to 25 shown in FIG. 8 can generate and regenerate an assigned type of table with reference to electronic program information stored in an electronic program information storage unit 11 and update information stored in an update information storage unit 41. In the example shown in FIG. 8, the table generation unit 21 generates NIT, the able generation unit 22 generates SDT, the table generation unit 23 generates EIT[current/next], the table generation unit 24 generates EIT[schedule]-1st-to-4th, and the table generation unit 25 generates EIT[schedule]-5th-to-8th.

When either of editor units 31 and 32 changes the description of an electronic program being broadcasted now, for example, there is a need to regenerate both EIT[current/next] and EIT[schedule] according to the change. In this case, only the table generation units 23 and 24 regenerate assigned tables and neither of the table generation units 21, 22, and 25 has the necessity for regenerating an assigned table, and therefore distribution of the load of generating one or more tables which constitute the electronic program guide table among the plurality of table generation units can be achieved.

Furthermore, when the editor unit 31 changes the description of an electronic program being broadcasted now and the editor unit 32 adds an electronic program to be broadcasted after one week, for example, there is a need to regenerate EIT[current/next], EIT [schedule]-1st-to-4th, and EIT[schedule]-5th-to-8th. In this case, only the table generation units 23, 24 and 25 regenerate assigned tables, and therefore distribution of the load of generating one or more tables which constitute the electronic program guide table among the plurality of table generation units can be achieved. In this case, neither of the table generation units 21 and 22 has the necessity for regenerating an assigned table.

Therefore, the electronic program guide providing device of the ninth embodiment of the present invention offers an advantage of being able to distribute the load of generating one or more tables which constitute the electronic program guide table among the plurality of table generation units.

It is also possible to dispose a plurality of table generation units each for generating two or more specific tables, instead of disposing the plurality of table generation units each for generating only one specific table. Furthermore, the configuration of the ninth embodiment can be applied to any one of the above-mentioned first to fourth and sixth to eighth embodiments other than the fifth embodiment. That is, the electronic program guide providing device according to any one of the above-mentioned first to fourth and sixth to eighth embodiments can be provided with a plurality of table generation units each for generating at least one specific table.

Embodiment 10.

The electronic program guide providing device according to any one of the above-mentioned first to ninth embodiments does not change the transmission timing of tables based on the state of generation of the tables. In contrast, an electronic program guide providing device according to a tenth embodiment of the present invention is so constructed as to adjust the transmission timing of tables based on the state of generation of the tables.

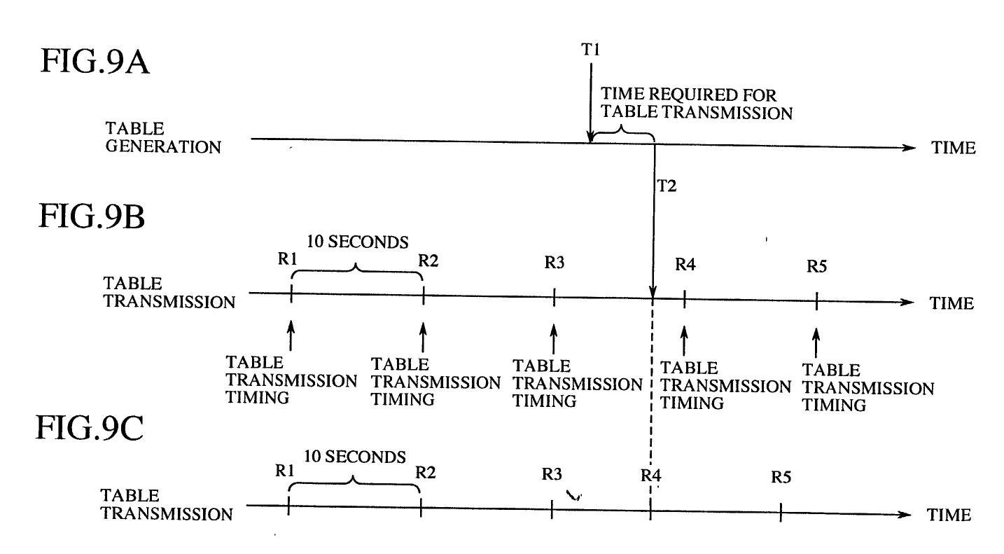

FIGS. 9(a) to 9(c) are timing charts showing an example of generation and transmission of a table in the electronic program guide providing device according to the tenth embodiment. FIG. 9(a) shows the generation timing of a certain table, FIG. 9(b) shows the transmission timing of the table, i.e., that the table is transmitted every 10 seconds in the above-mentioned second embodiment or the like, and FIG. 9(c) shows the transmission timing of the table according to the tenth embodiment, which changes after the table has been changed. As shown in FIG. 9(a), if a table generation unit 21 is notified of update information on updating of electronic program information by an editor unit 31, for example, at time T1, the table generation unit 21 generates a corresponding table and ends the table generation at time T2. Then, as shown in FIG. 9(b), since T2 is between the next sending times R3 and R4, the updated table will be transmitted at R4 in the above-mentioned second embodiment or the like.

However, according to the tenth embodiment, the table generation unit 21 does not send the table at the next sending time R4 but moves up the next and later sending times of the table after R4 by setting R4=T2 and then transmits the table at T2. Thus, the table generation unit 21 can send information on an updated table at an earlier time. Particularly, by applying the tenth embodiment to transmission of such a table that should be transmitted at an earlier time after it has been updated as EIT[current/next] showing an electronic program being broadcasted now or a table that is transmitted at long regular intervals, transmission of information on an updated table at an earlier time can be achieved. As shown in FIG. 9(c), after the table generation unit 21 moves up the next and later sending times of the table after R4 by setting R4=T2 and then transmits the table at T2, it keeps the later sending times and will transmit the updated table every ten minutes unless new updating is carried out.

Therefore, the tenth-embodiment of the present invention offers an advantage of being able to, once the table generation unit 21 is notified of updating of any table, transmit the updated table at an earlier time even though the table generation unit 21 is so constructed as to send the table at predetermined intervals.

Many widely different embodiments of the present invention may be constructed without departing from the spirit and scope of the present invention. It should be understood that the present invention is not limited to the specific embodiments described in the specification, except as defined in the appended claims.

What is claimed is:

1. An electronic program guide providing device comprising:
an editing means for editing electronic program information;
an electronic program information storage means for storing the electronic program information edited by said editing means;
a table generation means for generating an electronic program guide table by using the electronic program information stored in said electronic program information storage means, said device providing the generated electronic program guide table;
when updating the electronic program information stored in said electronic program information storage means, said editing means generating update information on the updating of the electronic program information; and
said table generation means updating the electronic program guide table based on said update information generated by said editing means by using the electronic program information stored in said electronic program information storage means.

2. The electronic program guide providing device according to claim 1, wherein said device further includes an update information storage means for storing the update information generated by said editing means, and wherein, when updating the electronic program information stored in said electronic program information storage means, said editing means stores the update information on the updating of the electronic program information in said update information storage means, and said table generation means generates the electronic program guide table based on the update information stored in said update information storage means by using the electronic program information stored in said electronic program information storage means.

3. The electronic program guide providing device according to claim 1, wherein said electronic program guide table consists of a plurality of electronic program information tables each of which corresponds to the type of electronic program information included therein, and said table generation means determines which electronic program information table has to be updated based on the update information on the updating of the electronic program information, and updates only one or more electronic program information tables that need to be updated.

4. The electronic program guide providing device according to claim 2, wherein said electronic program guide table consists of a plurality of electronic program information tables each of which corresponds to the type of electronic program information included therein, and said table generation means determines which electronic program information table has to be updated based on the update information on the updating of the electronic program information, and updates only one or more electronic program information tables that need to be updated.

5. The electronic program guide providing device according to claim 3, wherein said table generation means updates only one or more electronic program information tables that need to be updated at predetermined intervals.

6. The electronic program guide providing device according to claim 4, wherein said table generation means updates only one or more electronic program information tables that need to be updated at predetermined intervals.

7. The electronic program guide providing device according to claim 5, wherein said table generation means sets the length of predetermined intervals at which only one or more electronic program information tables that need to be updated are updated according to a sending frequency of an electronic program information table with the largest sending frequency.

8. The electronic program guide providing device according to claim 6, wherein said table generation means sets the length of predetermined intervals at which only one or more electronic program information tables that need to be updated are updated according to a sending frequency of an electronic program information table with the largest sending frequency.

9. The electronic program guide providing device according to claim 5, wherein said table generation means sets the length of predetermined intervals at which each of one or more electronic program information tables that need to be updated is updated according to a sending frequency of each of the one or more electronic program information tables.

10. The electronic program guide providing device according to claim 6, wherein said table generation means sets the length of predetermined intervals at which each of one or more electronic program information tables that need to be updated is updated according to a sending frequency of each of the one or more electronic program information tables.

11. The electronic program guide providing device according to claim 2, wherein said device includes a plurality of editing means, and each of said plurality of editing means inspects update information generated by any other editing means stored in said update information storage means.

12. The electronic program guide providing device according to claim 2, wherein said update information storage means stores histories of the update information generated by said editing means, and said editing means restores the electronic program information stored in said electronic program information storage means to the state it was prior to any updating done by said editing means with reference to the histories of the update information stored in said update information storage means if necessary.

13. The electronic program guide providing device according to claim 1, wherein said table generation means determines whether the updating of the electronic program information done by said editing means causes something wrong in the generation of the electronic program guide table, when determining so, notifies said editing means that there causes something wrong in the generation of the electronic program guide table, and invalidates the updating of the electronic program information.

14. The electronic program guide providing device according to claim 1, wherein said table generation means determines whether the updating of the electronic program information done by said editing means causes something wrong in the generation of the electronic program guide table, when determining so, notifies said editing means that there causes something wrong in the generation of the electronic program guide table, and urges said editing means to re-edit the electronic program information.

15. The electronic program guide providing device according to claim 12, wherein said table generation means determines whether the updating of the electronic program information done by said editing means causes something wrong in the generation of the electronic program guide table, when determining so, notifies said editing means that there causes something wrong in the generation of the electronic program guide table, and restores the electronic program information stored in said electronic program information storage means to the state it was prior to the updating of the electronic program information with reference to the histories of the update information stored in said update information storage means.

16. The electronic program guide providing device according to claim 1, wherein said device includes a plurality of table generation means for generating the electronic program guide table while sharing a load of generating the electronic program guide table.

17. The electronic program guide providing device according to claim 2, wherein said device includes a plurality of table generation means for generating the electronic program guide table while sharing a load of generating the electronic program guide table.

18. The electronic program guide providing device according to claim 1, wherein said table generation means provides the generated electronic program guide table at predetermined intervals, and, when updating the electronic program guide table, provides the electronic program guide table updated at the same time that it updates the electronic program guide table.

19. The electronic program guide providing device according to claim 2, wherein said table generation means provides the generated electronic program guide table at predetermined intervals, and, when updating the electronic program guide table, provides the electronic program guide table updated at the same time that it updates the electronic program guide table.
